(19) United States
(12) Patent Application Publication
(10) Pub. No.: US 2026/0233563 A1
(43) Pub. Date: Aug. 13, 2026

(54) TRAILER HITCH LOCK

(71) Applicant: B & W Custom Truck Beds. Inc., Humboldt, KS (US)

(72) Inventor: Dylan Cato, Sterling, VA (US)

(73) Assignee: B & W Custom Truck Beds. Inc., Humboldt, KS (US)

(21) Appl. No.: 19/536,777

(22) Filed: Feb. 11, 2026

Related U.S. Application Data
(60) Provisional application No. 63/756,935, filed on Feb. 11, 2025.

(51) Int. Cl. B60D 1/28; B60D 1/06; B60D 1/60

(52) U.S. Cl. CPC B60D 1/28; B60D 1/06; B60D 1/065; B60D 1/60

(57) ABSTRACT

A trailer hitch lock including a casing having a central hub and a plurality of first and second fin segments extending outward from the hub to form a lattice structure. The first fin segments extend in parallel spaced relation, and the second fin segments extend between adjacent first fin segments. Truncated fins extend transversely from at least some of the first fin segments and are positioned between adjacent second fin segments. The fin segments and truncated fins cooperate to obstruct cutting tools advanced toward the central hub and a hitch element received and locked therein. The lattice formed by the first and second fin segments defines lattice units having inwardly extending pockets into which the truncated fins project. In some embodiments, a pin cover extends from the casing to cover a head of a hitch pin, the pin cover thereby preventing removal of the hitch pin.

### CROSS REFERENCE TO RELATED APPLICATION

This application claims the benefit of U.S. Provisional Patent Application No. 63/756,935 filed Feb. 11, 2025, the disclosure of which is hereby incorporated herein in its entirety by reference.

### FIELD OF THE INVENTION

The present invention relates to trailer hitch locks, and in particular to such a lock that provides enhanced physical security for trailer hitches and elements thereof.

### BACKGROUND

Trailer hitches and hitch couplers are widely used to connect trailers and other towed equipment to towing vehicles. Because trailers are often stored outdoors, left unattended at worksites, or parked in publicly accessible locations, they are susceptible to theft. To deter unauthorized removal, a variety of trailer hitch locks and coupler locks have been developed that are intended to prevent a trailer from being coupled to a towing vehicle or detached from a secured state. Conventional trailer hitch locks typically include a body or housing that is positioned over or within a portion of a hitch element, together with a locking member that blocks access to or movement of a coupling component. While such devices may deter opportunistic theft, many known hitch locks are vulnerable to defeat using common cutting or prying tools. For example, exposed lock bodies, narrow cross-sections, and accessible fastener components may permit an individual to compromise the lock using hand tools, powered cutting tools, or leverage-based attacks.

Some existing hitch lock designs present relatively smooth or continuous exterior surfaces that can be readily engaged by cutting wheels, saw blades, or grinders. Once engaged, such tools may be used to remove enough material from the lock body to permit removal of the lock or access to the underlying hitch structure. Other lock designs may leave mounting hardware or coupling fasteners exposed, allowing removal or disassembly of hitch components even when a lock is present. Additionally, many hitch lock devices are designed for use with only a single class or size of hitch component, limiting their effectiveness across different hitch types and configurations. This may lead users to employ ill-fitting locks or adapters, which can reduce security and create additional attack points.

Accordingly, there remains a need for improved trailer hitch lock devices that provide enhanced resistance to cutting, grinding, and forced-access attacks, that better shield underlying hitch structures and fasteners, and that may be adapted for use with a variety of hitch types and geometries.

### SUMMARY

Embodiments of the invention are defined by the claims below, not this summary. A high-level overview of various aspects of the invention is provided here to introduce a selection of concepts that are further described in the Detailed Description section below. This summary is not intended to be used in isolation to determine the scope of the claimed subject matter. In brief, this disclosure describes, among other things, a trailer hitch lock configured to be mounted and lockably secured to a hitch element.

In one aspect, a trailer hitch lock includes a casing having a central hub and a plurality of fin segments extending outward from the central hub to form a protective shell. A locking assembly is received within the central hub and is advanceable to lockably secure the trailer hitch lock to a hitch element received by the casing. The fin segments include first fin segments extending in parallel spaced relation and second fin segments extending between adjacent first fin segments. Truncated fins extend from at least some of the first fin segments in generally transverse relation thereto, with the truncated fins positioned between adjacent second fin segments. The first and second fin segments intersect to define lattice units, with each lattice unit including adjacent first and second fin segments and defining a pocket extending inward toward the central hub. The truncated fins extend into the pockets formed by the lattice units.

In another aspect, a trailer hitch lock includes a casing having a central hub with fin segments extending outward therefrom, a locking assembly received within the central hub, and a pin cover securable to the casing. The pin cover extends forward from the central hub and extends in covering relationship over the head of a hitch pin, preventing access thereto. The pin cover may extend from an adapter received within the casing, and may include an end wall and a forwardly extending flange positioned to prevent lateral access to the hitch pin.

### DESCRIPTION OF THE DRAWINGS

Illustrative embodiments of the invention are described in detail below with reference to the attached drawing figures, and wherein:

FIG. 1 is a perspective view of a trailer hitch lock in accordance with an embodiment of the invention, viewed from above and to the right;

FIG. 2 is a perspective view of the trailer hitch lock of FIG. 1, viewed from above and to the right, and depicted with a locking assembly exploded away from a casing;

FIG. 3 is a section view of the locking assembly of the trailer hitch lock of FIG. 1, taken in a central longitudinal plane of the locking assembly and viewed from the right;

FIG. 4 is a section view of the casing of the trailer hitch lock of FIG. 1, taken in a central longitudinal plane of the casing and viewed from the right;

FIG. 5 is a perspective view of the casing of the trailer hitch lock of FIG. 1, viewed from above and to the right, and depicted with the casing exploded away from an adapter and a hitch element;

FIG. 6 is a perspective view of the adapter of FIG. 5, viewed from above and to the right;

FIG. 7 is a perspective view of an alternative embodiment of the trailer hitch lock, viewed from above and to the right, and depicted with the trailer hitch lock mounted and lockably secured to a hitch element;

FIG. 8 is a perspective view of an adapter of the trailer hitch lock of FIG. 7, viewed from above and to the right.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Directional references may be used herein for convenience in reference only and should not be interpreted in a limiting sense. For example, the words “upwardly,” “downwardly,” “rightwardly,” and “leftwardly” will refer to directions in the drawings to which reference is made, and the words “inwardly” and “outwardly” will refer to directions toward and away from, respectively, the geometric center of the embodiment being described and designated parts thereof. The words “front” or “forward” will refer to the left side of the page of the drawing to which reference is made, and the words “rear” or “rearward” will refer to the right side of the page of the drawing to which reference is made. The words “mounted,” “connected,” “joined,” “adjoined,” “attached,” “secured,” or variations thereof will refer to parts, elements, or components that are both formed separately or joined together, as by welding or through a mechanical coupling, or parts, elements, or components that are integrally formed together. The terms “about” or “approximately” as used herein denote deviations from the exact value by +/−10%, preferably by +/−5%, and/or deviations in the form of changes that are insignificant to the described function. Said terminology will include the words specifically mentioned, derivatives thereof, and words of a similar import.

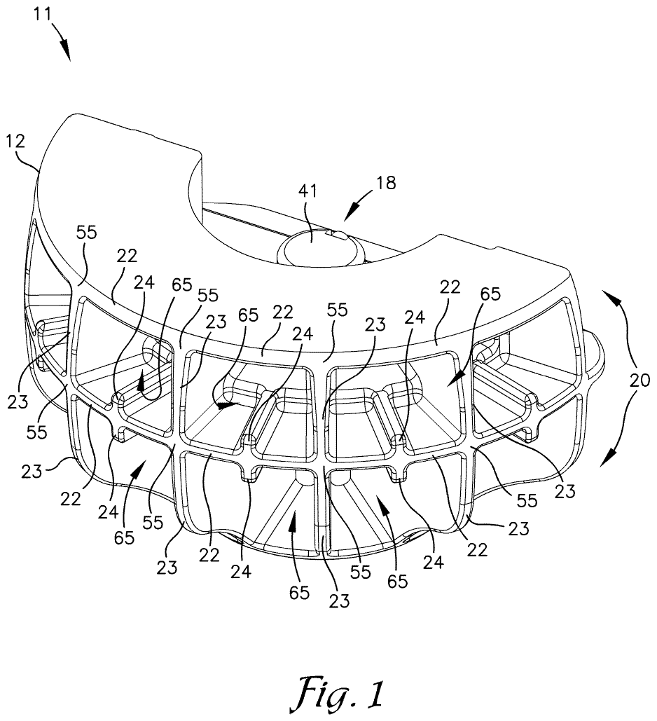

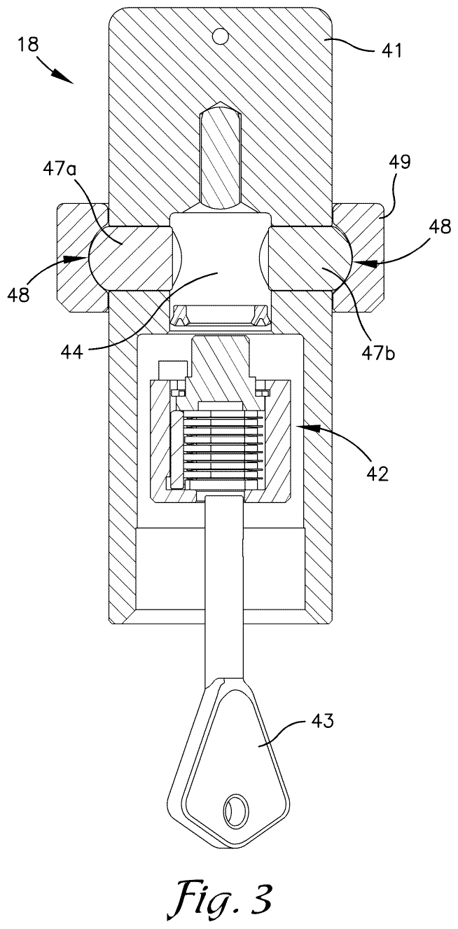

With reference to the embodiment shown in FIGS. 1-6, a trailer hitch lock 11 is described in accordance with an embodiment of the invention. The trailer hitch lock 11 includes a shell or casing 12 and is configured to be mounted and lockably secured to a hitch element 15 of a towed vehicle (not shown) such that the trailer hitch lock 11 prevents theft of the hitch element 15 and the towed vehicle itself. As will be described in greater detail herein, the trailer hitch lock 11 includes a locking assembly 18 selectively advanceable between a locked position, wherein the locking assembly 18 lockably secures the trailer hitch lock 11 to the hitch element 15, and an unlocked position, wherein the trailer hitch lock 11 is advanceable onto or removable from the hitch element 15.

The casing 12 comprises a lattice-like structure or lattice 20 which extends outward away from a casing hub or core 21. In the embodiments shown and described herein, the lattice 20 extending outward from the casing hub 21 includes first or horizontal fin segments 22 and second or vertical fin segments 23. The first fin segments 22 extend in respective spaced apart planes extending in generally parallel relation to each other, and the second fin segments 23 extend in respective spaced apart planes extending in angularly offset relation to each other, with each of the planes in which the respective second fin segments 23 extend converging at an axis extending longitudinally through the center of the locking assembly 18, which may be referred to herein as a central axis or bolt axis. The second fin segments 23 extend between adjacent first fin segments 22 such that the first and second fin segments 22 and 23 cooperate to form the lattice 20. Truncated fins or protrusions 24 are formed on certain ones of the horizontal fin segments 22. Each protrusion 24 projects away from the respective horizontal fin segments 22 on which it is formed, with each protrusion 24 oriented between, and spaced apart from, adjacent vertical fin segments 23.

The casing 12 defines a hitch receiving slot 28 into which a portion of the hitch element 15 is receivable. The hitch lock 11 is configured for use with various hitch elements (e.g., bumper pull hitches, gooseneck coupler hitches, fifth wheel hitches, and pintle hitches) and may include an adapter 30 sized to fit within the hitch receiving slot 28, with the adapter 30 extending between the casing hub 21 and the hitch element 15 such that the trailer hitch lock 11 fits snugly against the hitch element 15 when mounted thereto. As will be described in greater detail herein, in an embodiment, the adapter extending between the hitch element 15 and the casing 12 may include a cover extending in covering relationship over bolts that secure the hitch element 15 to a connecting structure extending between the hitch element 15 and a towing vehicle (not shown) to which the hitch element 15 is secured, with the cover preventing inadvertent removal or theft of the bolts when the trailer hitch lock 11 is mounted to the hitch element 15.

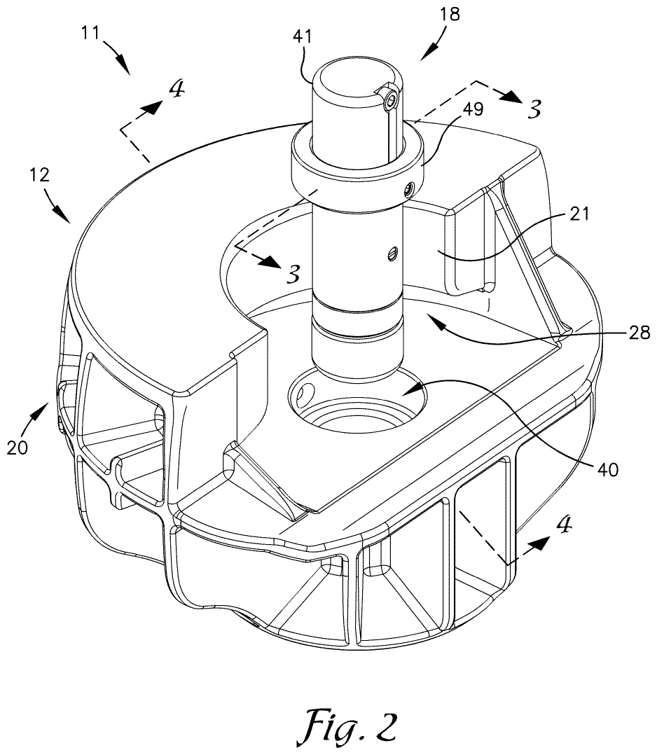

Referring now to FIGS. 2, 4, and 5, the casing 12 defines a lock receiving chamber 40 sized to receive the locking assembly 18, which includes a bolt 41 in which a lock mechanism 42 is housed. The lock mechanism 42 receives a key 43 which, when inserted into the lock mechanism 42, allows the bolt 41 to traverse the lock receiving chamber 40 in the bolt axis, which extends longitudinally through the lock receiver chamber 40. When the locking assembly 18 is advanced to the locked position, the bolt 41 advances out of the lock receiving chamber 40 and into the hitch receiving slot 28, and when the locking assembly 18 is advanced to the unlocked position, the bolt 41 is drawn out of the hitch receiving slot 28 and extends within the lock receiving chamber 40. The lock mechanism 42 includes a cam 44 which, when the key 43 is inserted into the lock mechanism 42 and the bolt 41 is advanced into the hitch receiving slot 28, is rotatable to drive a pair of lock arms 47a, 47b into and out of an arm receiving groove 48 formed within a lock ring 49 which is affixed to the casing hub 21. When the cam 44 is rotated such that the lock arms 47a, 47b project into the groove 48, the lock arms 47a, 47b retain the locking assembly 18 in the locked position such that the trailer hitch lock 11 is lockably mounted to the hitch element 15. The locking assembly disclosed in U.S. Pat. No. 11,766,905 to Cato et al. is an exemplary configuration of a locking assembly usable to lockably mount the trailer hitch lock 11 to the hitch element 15; the disclosure provided by the '905 Patent with respect to such an exemplary locking assembly and its elements, including its lock mechanism, set screws, tumblers, anti-drilling rings, end caps, etc., is incorporated herein by reference.

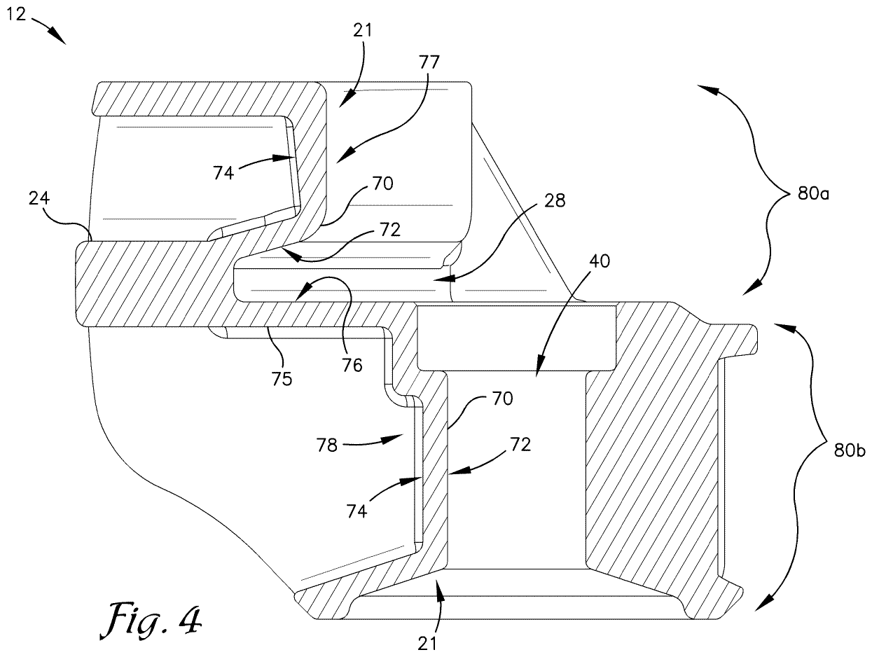

Referring now to FIGS. 1 and 4, the lattice 20 formed by the first and second fin segments 22 and 23 extends outward from the casing hub 21 to form an outer boundary beyond which a destructive cutting tool, such as an angle grinder, must pass to engage the casing hub 21, and the hitch element 15 covered thereby. The first and second fin segments 22 and 23 are spaced relative to each other such that, when a prospective thief advances an angle grinder or like cutting tool toward the casing hub 21, the blade of the cutting tool engages a plurality of fin segments 22, 23, and/or protrusions 24 projecting therefrom. Each of the first fin segments 22 extends between a pair of adjacent second fin segments 23 and each of the second fin segments 23 extends between a pair of adjacent first fin segments 22, with the intersection of the respective first and second fin segments 22 and 23 forming junctions or nodes 55. In the embodiment shown, the first and second fin segments 22 and 23 are oriented to intersect each other transversely, or at an angle of approximately ninety degrees. It should be understood, however, that the illustrated approximately ninety-degree intersection between the first and second fin segments 22 and 23 is exemplary only, and that the first and second fin segments 22 and 23 may intersect each other at acute or obtuse angles without departing from the scope of embodiments of the invention shown and described herein.

The first and second fin segments 22 and 23, and the respective junctions 55 thereof, cooperate to apportion the lattice 20 into a plurality of units, which may be referred to herein as “lattice units,” with each unit comprising a plurality of first fin segments 22, a plurality of second fin segments 23, the junctions 55 formed thereby, and at least one truncated fin 24. In the embodiment shown, each lattice unit comprises a pair of adjacent first fin segments 22 and a pair of adjacent second fin segments 23, with the first and second fin segments 22 and 23 of each lattice unit (and the junctions 55 formed thereby) cooperating to form a pocket or void 65 which extends inward from the outer boundary of the lattice 20 to the casing hub 21. It is foreseen that the lattice units of the casing 12 may comprise geometries other than those shown and described herein, including generally triangular, pentagonal, hexagonal, etc. Further, it is foreseen that different lattice units within the lattice 20 may have different geometries.

The truncated fin 24 of each lattice unit protrudes from a first fin segment 22 into the pocket 65 thereof, with the truncated fin 24 extending into the pocket 65 a distance sufficient such that the truncated fin 24 abuts against a head of an angle grinder as the grinder blade cuts through the first and/or second fin segments 22 and/or 23 of a respective lattice unit upon advancement of the angle grinder toward the casing hub 21 of the trailer hitch lock 11. The truncated fin 24 extends between and is spaced apart from the pair of second fin segments 23 of the lattice unit, with the truncated fin 24 of the embodiment shown spaced approximately equidistant from each of the second fin segments 23 such that the truncated fin 24 may be referred to as a “mid-fin” structure 24. It should be understood, however, that the truncated fin 24 may be spaced nearer to one fin segment 23 or another without departing from the scope of embodiments of the invention shown and described herein. It should further be understood that the truncated fin 24 may project into the pocket 65 from other elements of the lattice unit, including the second fin segments 23 or the junctions 55, and that each lattice unit may comprise a plurality of truncated fins 24 extending from various elements thereof.

Referring still to FIG. 4, the casing hub 21 is centrally oriented within the trailer hitch lock 11 such that the central axis extends through the casing hub 21, with the fin segments 22, 23, and protrusions 24 of the casing lattice 20 protecting the casing hub 21 (and the hitch element 15 and locking assembly 18 received thereby) from destruction via a cutting tool such as an angle grinder. The casing hub 21 comprises a hub wall 70 with an inner surface 72 which defines the hitch receiving slot 28 and the lock receiving chamber 40, and an outer surface 74 from which the lattice 20 extends. The hub wall 70 includes a hub base 75 that extends in a plane extending generally parallel to the respective planes in which the first fin segments 22 extend, with the hitch element 15 abutting against an abutment surface 76 of the hub base 75 when received within the hitch receiving slot 28. The lock receiving chamber 40 extends into the hub base 75, such that the bolt 41 extends through the plane in which the hub base 75 extends upon advancement of the bolt 41 into and out of the hitch receiving slot 28.

The hub wall 70 includes a first or upper section 77 and a second or lower section 78, which extend away from and cooperate with the hub base 75 to form upper and lower portions 80a and 80b, respectively, of the casing hub 21. The hitch receiving slot 28 is formed in the upper portion 80a of the hub 21, which may be referred to as the hitch receiving portion 80a, and the lock receiving chamber 40 is formed in the lower portion 80b of the hub 21, which may be referred to as the lock receiving portion 80b. The hitch receiving section 80a is shaped such that the inner surface 72 of the hub wall 70 extends in closely spaced relation to corresponding surfaces of the hitch element 15 (e.g., a flanged lip extending around a hitch ball receiver thereof) and/or the adapter 30, and the lock receiving portion 80b is shaped such that the inner surface 72 of the hub wall 70 receives the lock ring 49 of the locking assembly 18 and extends in closely spaced relation to the bolt 41. The outer surface 74 of the hub wall 70 defines the depth of the pocket 65 formed between the first and second fin segments 22 and 23 extending outward therefrom. It is foreseen that, in a preferred embodiment, the first and second fin segments 22 and 23 may extend outward from the outer surface 74 of the hub wall 70 a distance within the range of 36-100mm, as disclosed in the '905 Patent; the disclosure provided by the '905 Patent with respect to such outwardly extending fin segments is incorporated herein by reference. In the embodiment shown and as best seen in FIG. 4, the truncated fin 24 extends outward from the outer surface 74 of the hub wall 70 to the outer boundary of the casing 12, such that the hub wall 70 provides structural support to the truncated fin 24 to bolster the strength and rigidity thereof.

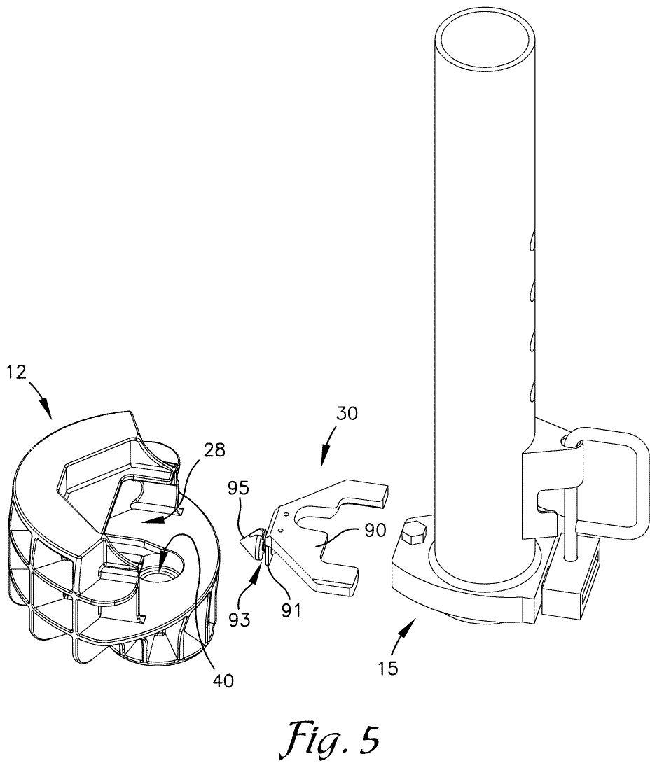

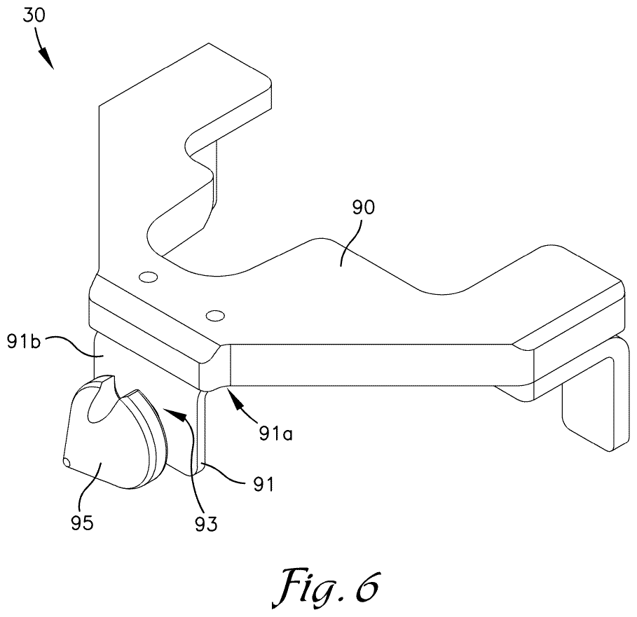

Referring now to FIGS. 5-6, the adapter 30 is shaped in correspondence with the hitch element 15 and the hitch receiving slot 28 formed by the casing 12, with the adapter 30 extending between the hitch element 15 and the inner and abutment surfaces 72 and 76 of the hub wall 70 such that the adapter 30 establishes a snug fit between the hitch element 15 and the casing hub 21 when the trailer hitch lock 11 is mounted thereto. It should be understood that although truncated fins are not depicted in the embodiment of the casing depicted in FIG. 5, it is entirely within the ambit of exemplary embodiments to provide such a casing comprising a lattice with protrusions such as the truncated fins 24 shown and described herein.

The adapter 30 includes a base plate 90 to which a tab 91 is securable, with the tab 91 having a first or base connecting section 91a and a second or casing connecting section 91b. The first tab section 91a abuts against the base plate 90 and is securable thereto, and the second tab section 91b abuts against the inner surface 72 of the hub wall 70 and is securable thereto by a fastener 93 which extends through the hub wall 70 to be received by an adapter nut 95 which fits snugly against the outer surface 74 of the hub wall 70 and is configured to extend between first and second fin segments 22 and 23 of a lattice unit. One or more notches may be formed in the adapter nut 95, with the notches sized to receive corresponding truncated fins 24 of the lattice unit within which the adapter nut 95 is positioned. In an embodiment, the adapter nut 95 may comprise a conic structure with a curved outer surface against which it is difficult to effectively position a drill bit.

The base plate 90 of the adapter 30 shown and described herein is configured to receive a hitch element 15 of a gooseneck-type trailer hitch coupler, with the base plate 90 shaped to extend adjacent to and fit snugly against the flanged hitch ball receiver lip of the hitch element 15. It should be understood, however, that the hitch receiving slot 28 formed by the casing 12 of the trailer hitch lock 11 is sized sufficiently to receive various hitch elements 15, including those of gooseneck hitches, bumper pull hitches, fifth wheel hitches, and pintle hitches. To that end, the trailer hitch lock shown and described herein may be referred to as a “universal” trailer hitch lock or a “modular” trailer hitch lock, within which a plurality of interchangeable adapters are receivable. The universal trailer coupling lock disclosed in U.S. Patent Application Publication No. 2025/0018754 to Cato is an exemplary configuration of a universal trailer hitch lock usable to receive hitch elements and adapters of varying size; the disclosure provided by the '754 Publication with respect to such an exemplary universal trailer hitch lock is incorporated herein by reference.

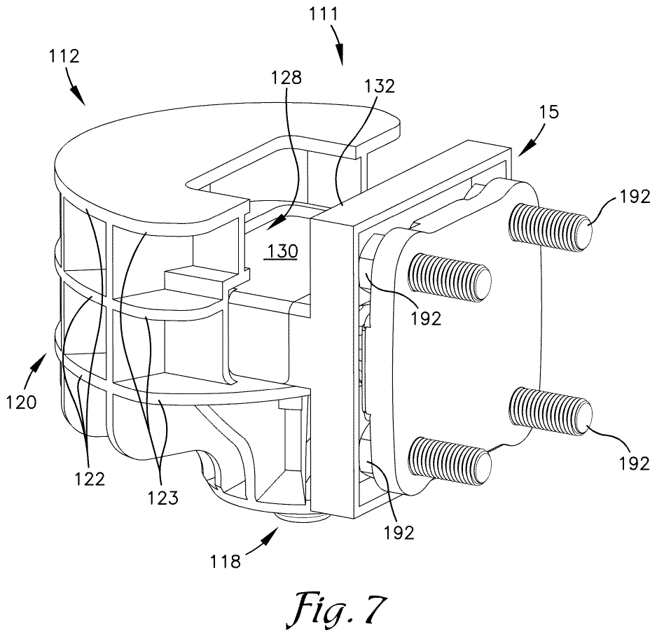

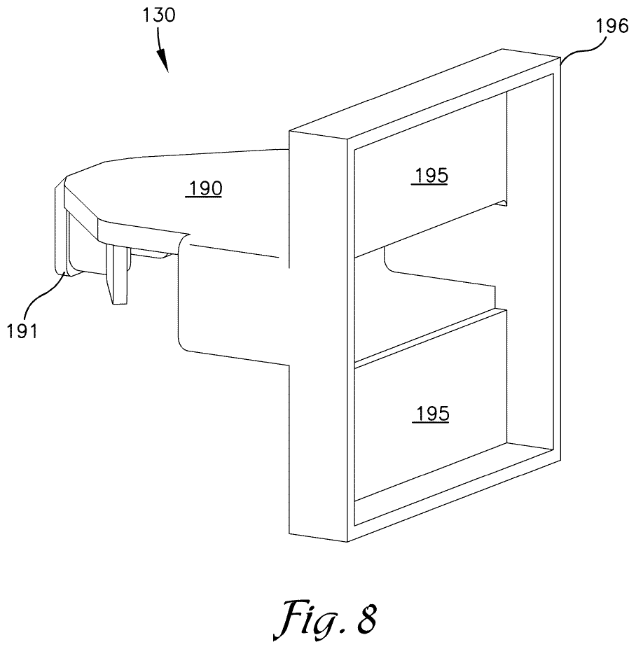

FIGS. 7-8 depict an alternative embodiment of the trailer hitch lock, which is denominated herein as trailer hitch lock 111. Like the trailer hitch lock 11, the trailer hitch lock 111 is configured to be mounted and lockably secured to a hitch element 15 of a towed vehicle (not shown), and includes a casing 112 for receiving the hitch element 15 and a locking assembly 118 which is selectively advanceable between a locked position and an unlocked position. It should be understood that although truncated fins are not depicted in the lattice 120 of the casing 112, it is entirely within the ambit of exemplary embodiments to provide a configuration of the trailer hitch lock 111 wherein truncated fins extend from one or more of the first and second fin segments 122 and 123 forming the lattice 120 of the casing 112.

The casing 112 receives an adapter 130 which is sized to be received within a hitch receiving slot 128 such that the adapter 130 extends between and fits snugly against the casing 112 and the hitch element 15. As best shown in FIG. 8, the adapter 130 includes a cover 132 which extends from the base plate 190 opposite the tab 191, with the cover 132 extending toward bolts 192 that secure a pintle ring of a hitch element 15 to a towed vehicle. In the embodiment shown, the cover 132 comprises an end wall 195 extending generally orthogonal to the base plate 190, with the end wall 195 extending just rearward of and in closely spaced relation to the heads of the bolts 192. A peripheral flange 196 extends forward from the end wall 195 a distance sufficient to prevent the heads of the bolts 192 from being accessed laterally, or from the sides of the hitch element 15. It should be understood that the cover may have a geometry different than that of the cover 132 shown and described herein, as may be necessary to effectively protect bolts or other fasteners used with the various hitch elements receivable by the universal trailer hitch lock 111. For example, it is foreseen that the cover 132 may comprise a pair of side beams which extend rearward from the base plate 190 to extend in covering relationship over pins which secure a hitch assembly of a hitch element 15 to a drawbar thereof.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure is intended to demarcate those structures as including a plurality of possible arrangements or designs within the scope of the disclosure and readily identifiable by one of skill in the art to perform the particular function in a similar way without specifically listing all such arrangements or designs. Certain features and sub-combinations are of utility and may be employed without reference to other features and sub-combinations and are contemplated within the scope of the claims.

As used in the claims, identification of an element with an indefinite article “a” or “an” or the phrase “at least one” is intended to cover any device assembly including one or more of the elements at issue. Similarly, references to first and second elements, or to a pair of elements, is not intended to limit the claims to such assemblies including only two of the elements but rather is intended to cover two or more of the elements at issue. Only where limiting language such as “a single” or “only one” with reference to an element, is the language intended to be limited to one of the elements specified, or any other similarly limited number of elements.

1. A trailer hitch lock comprising:
a casing having:
a plurality of first fin segments extending outward from a central hub, each of the first fin segments extending in parallel spaced relation from adjacent ones of other first fin segments;
a plurality of second fin segments extending outward from the central hub, each of the second fin segments extending in spaced relation from adjacent ones of other second fin segments and between adjacent ones of the first fin segments; and
a plurality of truncated fins extending from at least some of the first fin segments in generally transverse relation therefrom, each of the truncated fins oriented between and spaced apart from adjacent ones of the second fin segments; and
a locking assembly extending within the central hub of the casing.

2. The trailer hitch lock as in claim 1, further comprising a plurality of lattice units, each of the lattice units comprising adjacent ones of the first fin segments and adjacent ones of the second fin segments extending therebetween.

3. The trailer hitch lock as in claim 2, wherein each of the lattice units defines a pocket extending between the adjacent ones of the first fin segments and the adjacent ones of the second fin segments, the pocket extending inward toward the central hub.

4. The trailer hitch lock as in claim 3, wherein each of the truncated fins extends into the pocket of one of the lattice units.

5. The trailer hitch lock as in claim 2, wherein at least one of the lattice units includes a plurality of truncated fins.

6. The trailer hitch lock as in claim 1, wherein each of the truncated fins is spaced approximately equidistant from adjacent ones of the second fin segments.

7. The trailer hitch lock as in claim 1, wherein at least some of the first fin segments and at least some of the second fin segments intersect each other at approximately ninety degree angles.

8. The trailer hitch lock as in claim 1, wherein the central hub includes a hub wall having an inner surface defining a hitch receiving slot in which a hitch element is receivable, and a lock receiving chamber in which the locking assembly extends.

9. The trailer hitch lock as in claim 8, wherein an adapter is extendable between the inner surface of the hub wall and the hitch element.

10. A trailer hitch lock comprising:
a casing having:
a plurality of first fin segments extending outward from a central hub, each of the first fin segments extending in parallel spaced relation from adjacent ones of other first fin segments;
a plurality of second fin segments extending outward from the central hub, each of the second fin segments extending in spaced relation from adjacent ones of other second fin segments and between adjacent ones of the first fin segments; and
a locking assembly extending within the central hub of the casing; and
a pin cover securable to the casing, the pin cover extending forward from the central hub such that the pin cover extends in covering relationship over a head of a hitch pin.

11. The trailer hitch lock as in claim 10, wherein the pin cover extends from an adapter receiving within the casing.

12. The trailer hitch lock as in claim 11, wherein the adapter is secured to the pin casing by an adapter nut.

13. The trailer hitch lock as in claim 10, wherein the pin cover includes an end wall and a flange extending therefrom.

14. The trailer hitch lock as in claim 13, wherein the flange extends forward from the end wall to prevent lateral access to the hitch pin.

15. The trailer hitch lock as in claim 10, further comprising a lattice extending outward from the central hub.

16. The trailer hitch lock as in claim 15, wherein the lattice includes a plurality of first fin segments and a plurality of second fin segments intersecting to form lattice units.
